(19) United States
(12) Patent Application Publication
(10) Pub. No.: US 2026/0172134 A1
(43) Pub. Date: Jun. 18, 2026

(54) GW APPARATUS AND OPTICAL SIGNAL PROCESSING METHOD

(71) Applicant: NIPPON TELEGRAPH AND TELEPHONE CORPORATION, Tokyo (JP)

(72) Inventors: Yasutaka KIMURA, Musashino-shi (JP); Junichi KANI, Musashino-shi (JP); Naotaka SHIBATA, Musashino-shi (JP); Shin KANEKO, Musashino-shi (JP)

(73) Assignee: NIPPON TELEGRAPH AND TELEPHONE CORPORATION, Tokyo (JP)

(21) Appl. No.: 19/125,667

(22) PCT Filed: Nov. 7, 2022
(86) PCT No.: PCT/JP2022/041359

§ 371 Date: Apr. 29, 2025

(51) Int. Cl. H04J 14/02; H04B 10/40

(52) U.S. Cl. CPC H04J 14/022; H04B 10/40; H04J 14/0202

(57) ABSTRACT

There is provided a GW device including: a main signal path control device that performs line concentration/distribution and adding/dropping on a received main signal; and a subscriber control device that is provided between the main signal path control device and a subscriber terminal and transmits and receives the main signal and a control signal to and from the subscriber terminal, in which the main signal path control device is separable from the subscriber control device.

### TECHNICAL FIELD

The present invention relates to a GW device and an optical signal processing method.

### BACKGROUND ART

There is a network called an all photonics network (APN) that enables optical direct connection without electrical processing at each point. Examples of devices constituting the APN include a subscriber terminal disposed at an end point, a photonic exchange (an EX device) having a function of cross-connecting optical paths on core mesh surfaces, and a photonic gateway (a GW device) connected to the subscriber terminal.

### CITATION LIST

### Non Patent Literature

Non Patent Literature 1:“Novel System Architecture toward the Realization of All-photonics Network”, the Journal of Institute of Electronics, Information and Communication Engineers, Vol.104 No. 5pp. 471-477.

### SUMMARY OF INVENTION

### Technical Problem

The GW device has a plurality of functions. However, in a state where the GW device has a configuration in which functions are integrated, in a case where some functions in the GW device need to be replaced, it is necessary to replace the entire GW device including other functions.

An object of the present invention is to provide a GW device in which some functions can be replaced.

### Solution to Problem

According to an aspect of the present invention, there is provided a GW device including: a main signal path control device that performs line concentration/distribution and adding/dropping on a received main signal; and a subscriber control device that is provided between the main signal path control device and a subscriber terminal and transmits and receives the main signal and a control signal to and from the subscriber terminal, in which the main signal path control device is separable from the subscriber control device.

### ADVANTAGEOUS EFFECTS OF INVENTION

In the GW device of the present invention, some functions can be replaced.

### BRIEF DESCRIPTION OF DRAWINGS

FIG. 1 is a diagram illustrating a configuration of a GW device according to a first embodiment.

FIG. 2 is a flowchart illustrating a procedure for replacing a main signal path control device in the GW device according to the first embodiment.

FIG. 3 is a diagram illustrating an example of a configuration of the GW device according to a second embodiment.

FIG. 4 is a flowchart illustrating a procedure for replacing the main signal path control device in the GW device according to the second embodiment.

### DESCRIPTION OF EMBODIMENTS

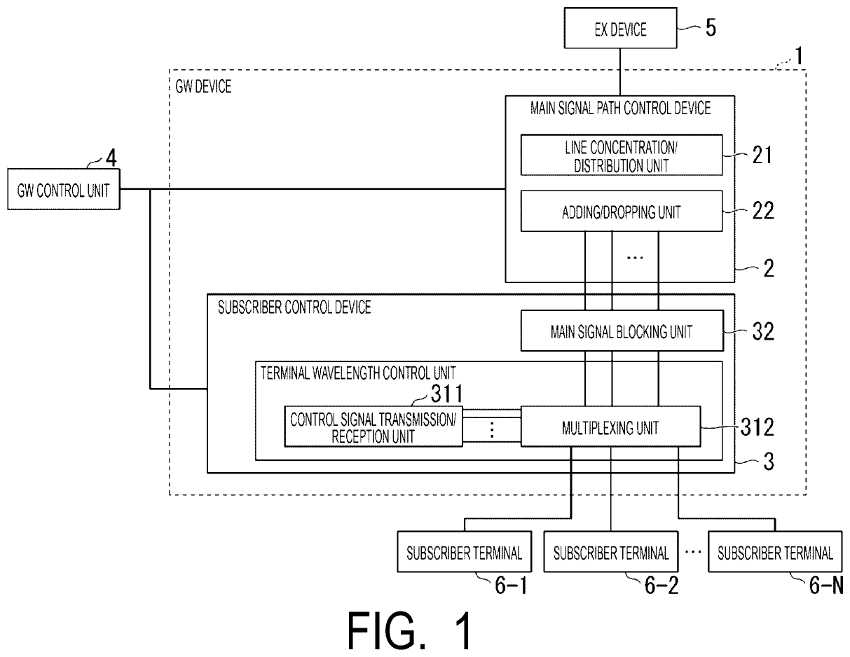

Hereinafter, embodiments of the present invention will be described with reference to the drawings. FIG. 1 is a diagram illustrating a configuration of a GW device 1 according to a first embodiment. The GW device 1 is provided between an EX device 5 and a subscriber terminal 6. The EX device 5 and the subscriber terminal 6 input and output a main signal via the GW device 1. The GW device 1, the EX device 5, and the subscriber terminal 6 constitute a part of an APN architecture.

The GW device 1 includes a main signal path control device 2 and a subscriber control device 3. The main signal path control device 2 and the subscriber control device 3 are connected to each other via an optical path. The main signal path control device 2 and the subscriber control device 3 can be separated from each other. Therefore, the main signal path control device 2 and the subscriber control device 3 can be replaced with new devices or the like.

The main signal path control device 2 includes a line concentration/distribution unit 21 and an adding/dropping unit 22. The line concentration/distribution unit 21 concentrates or distributes optical paths connected to the subscriber control device 3. The adding/dropping unit 22 adds a signal having a specific wavelength to an optical signal that is input from the EX device 5 or the subscriber control device 3 or extracts a signal having a specific wavelength from an optical signal that is input from the EX device 5 or the subscriber control device 3. That is, the adding/dropping unit 22 performs optical adding/dropping on an optical signal.

The main signal path control device 2 includes, for example, a power splitter and an optical switch. Functions of the main signal path control device 2 are implemented by optical signal division by the power splitter and selection of the optical signal by the optical switch for connection with the subscriber terminal 6. The main signal path control device 2 includes, for example, arrayed waveguide gratings (AWG) and an optical switch. The functions of the main signal path control device 2 are implemented by wavelength multiplexing/demultiplexing by the AWG and path selection by the optical switch.

The subscriber control device 3 includes a terminal wavelength control unit 31 and a main signal blocking unit 32. The terminal wavelength control unit 31 includes a control signal transmission/reception unit 311 and a multiplexing unit 312.

The control signal transmission/reception unit 311 outputs a control signal to the multiplexing unit 312. The control signal transmission/reception unit 311 may change a wavelength of the control signal to be transmitted and received. The wavelength of the control signal to be transmitted and received by the control signal transmission/reception unit 311 is determined by, for example, an external GW control unit 4. The wavelength of the control signal to be transmitted and received by the control signal transmission/reception unit 311 is set to be, for example, a wavelength different from the wavelength of the main signal. As the wavelength of the control signal, for example, a wavelength outside a range of wavelengths that can be used for the main signal is fixedly allocated. The wavelength that can be used for the main signal is determined in advance. The wavelength of the control signal may be changed by, for example, the control signal transmission/reception unit 311 that can change the wavelength of the control signal, and may be set to a wavelength different from the wavelength of the main signal. The subscriber control device 3 may include a plurality of control signal transmission/reception units 311, and each of the control signal transmission/reception units 311 may be connected to one subscriber terminal 6 via the multiplexing unit 312. Alternatively, one control signal transmission/reception unit 311 may have a function equivalent to a function of an OLT in a passive optical network (PON), and may be connected to the subscriber terminal 6 via an optical splitter.

The multiplexing unit 312 transmits and receives an optical signal to and from the main signal path control device 2, the subscriber terminal 6, and the control signal transmission/reception unit 311. The multiplexing unit 312 relays the control signal transmitted and received between the subscriber terminal 6 and the control signal transmission/reception unit 311. The multiplexing unit 312 relays the main signal transmitted and received between the subscriber terminal 6 and the main signal path control device 2. The multiplexing unit 312 transmits and receives an optical signal obtained by multiplexing the main signal and the control signal to and from the subscriber terminal 6. The multiplexing unit 312 includes, for example, a wavelength filter that demultiplexes the optical signal into light having the wavelength of the control signal and light having the wavelength of the main signal, demultiplexes the optical signal input from the subscriber terminal 6 into the control signal and the main signal, outputs the control signal to the control signal transmission/reception unit 311, and outputs the main signal to the main signal path control device 2.

The main signal blocking unit 32 blocks the main signal transmitted and received between the subscriber terminal 6 and the main signal path control device 2. Whether or not the main signal blocking unit 32 blocks the main signal is controlled and determined by the GW control unit 4.

The GW control unit 4 controls the GW device 1. The GW control unit 4 controls, for example, the control signal transmission/reception unit 311 to change the wavelength of the control signal to be transmitted and received. The GW control unit 4 may include an input device and an output device, control the GW device 1 based on an input, and output data that is output from the GW device 1 to a display device or the like.

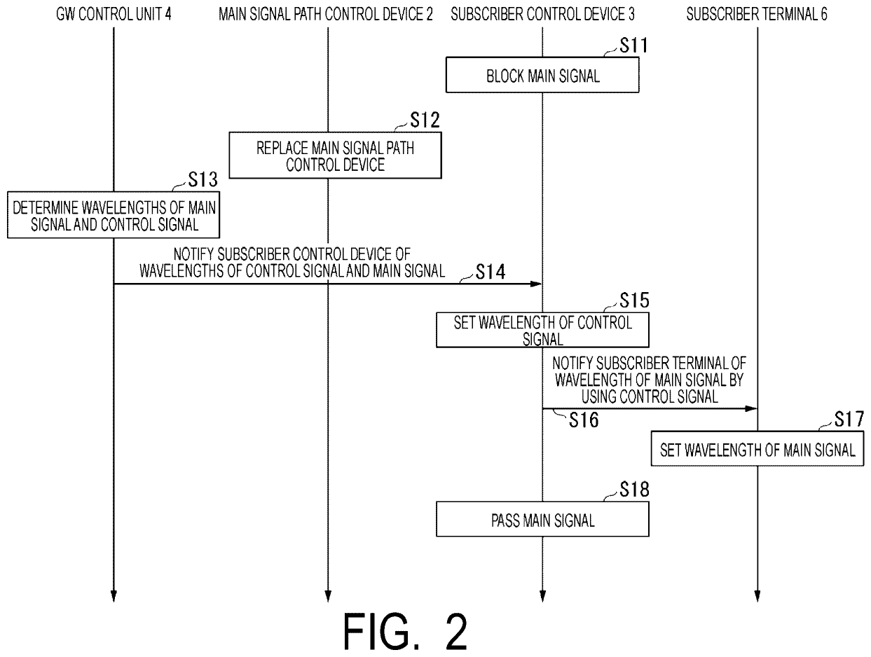

FIG. 2 is a flowchart illustrating a procedure for replacing the main signal path control device 2 in the GW device 1 according to the first embodiment. First, the main signal blocking unit 32 blocks the main signal transmitted and received between the main signal path control device 2 and the terminal wavelength control unit 31 (step S11). The main signal blocking unit 32 is controlled by the GW control unit 4, and blocks the main signal. The GW control unit 4 controls the main signal blocking unit 32. When the main signal is blocked, the GW control unit 4 may output, to a display device or the like, data for notifying a user of the GW device 1 that the main signal is blocked. Thereafter, the user of the GW device 1 replaces the main signal path control device 2 with a new device (step S12). In response to an attachment of the main signal path control device 2, the GW device 1 may notify the GW control unit 4 that the main signal path control device 2 is attached. Thereafter, the GW control unit 4 determines the wavelengths of the main signal and the control signal for each optical path (step S13). The GW control unit 4 determines the wavelengths such that the wavelengths of the main signal and the control signal are different for each optical path. The GW control unit 4 notifies the control signal transmission/reception unit 311 of the determined wavelengths of the control signal and the main signal (step S14). The control signal transmission/reception unit 311 sets a wavelength of the control signal to the notified wavelength of the control signal (step S15).

The control signal transmission/reception unit 311 transmits a control signal to the subscriber terminal 6 via the multiplexing unit 312. The control signal includes information on the wavelength of the main signal. Thereby, the control signal transmission/reception unit 311 notifies the subscriber terminal 6 of the wavelength of the main signal (step S16). The subscriber terminal 6 sets the notified wavelength as the wavelength of the main signal (step S17). Thereafter, the main signal blocking unit 32 passes the main signal transmitted and received between the main signal path control device 2 and the terminal wavelength control unit 31 (step S18).

As described above, in the GW device 1 according to the first embodiment, only the main signal path control device 2 having the line concentration/distribution function and the adding/dropping function can be replaced. Therefore, in the GW device 1 according to the first embodiment, some functions can be easily replaced.

Further, the wavelength of the control signal transmitted and received by the control signal transmission/reception unit 311 is set to be different from the wavelength of the main signal. Therefore, it is possible to reduce a possibility that the wavelength of the main signal and the wavelength of the control signal overlap and control cannot be performed.

### Second Embodiment

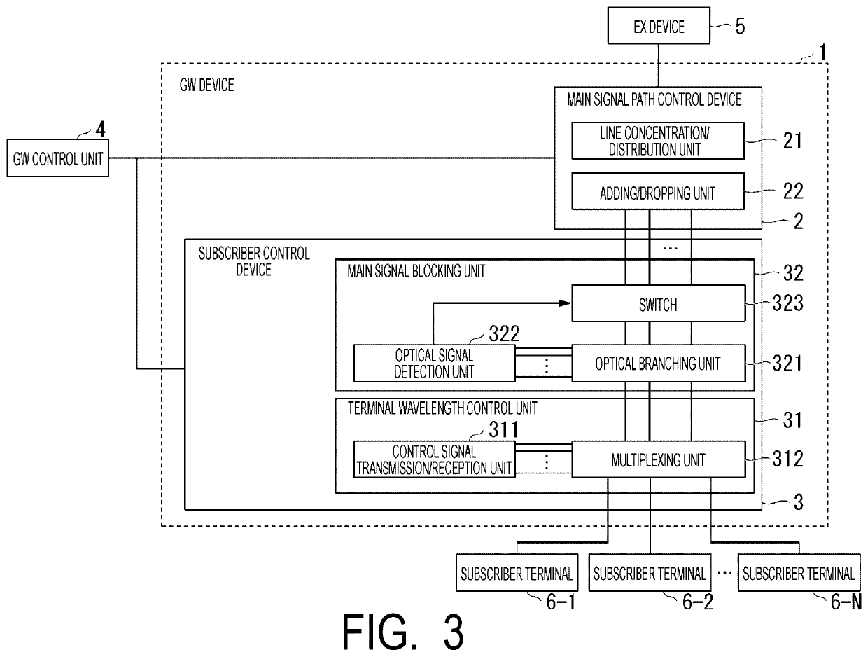

FIG. 3 is a diagram illustrating an example of a configuration of the GW device 1 according to a second embodiment. In the GW device 1 according to the second embodiment, unlike the GW device 1 according to the first embodiment, the main signal blocking unit 32 includes an optical branching unit 321, an optical signal detection unit 322, and a switch 323.

The optical branching unit 321 branches the main signal transmitted from the subscriber terminal 6, and outputs the branched main signal to the optical signal detection unit 322 and the switch 323. The optical signal detection unit 322 stores the wavelength of the main signal for each optical path. The optical signal detection unit 322 determines whether or not the wavelength of the optical signal that is input from the optical branching unit 321 is equal to the stored wavelength of the main signal. In a case where the wavelength of the optical signal input from the optical branching unit 321 is different from the stored wavelength of the main signal, the optical signal detection unit 322 controls the switch 323 to block the optical signal transmitted to the optical path.

The switch 323 is provided between the optical branching unit 321 and the main signal path control device 2. The switch 323 can block the main signal transmitted and received between the optical branching unit 321 and the main signal path control device 2.

In a case where the switch 323 is controlled by the GW control unit 4 and can block the main signal transmitted and received between the optical branching unit 321 and the main signal path control device 2, the main signal blocking unit 32 according to the second embodiment has the same function as the main signal blocking unit 32 according to the first embodiment.

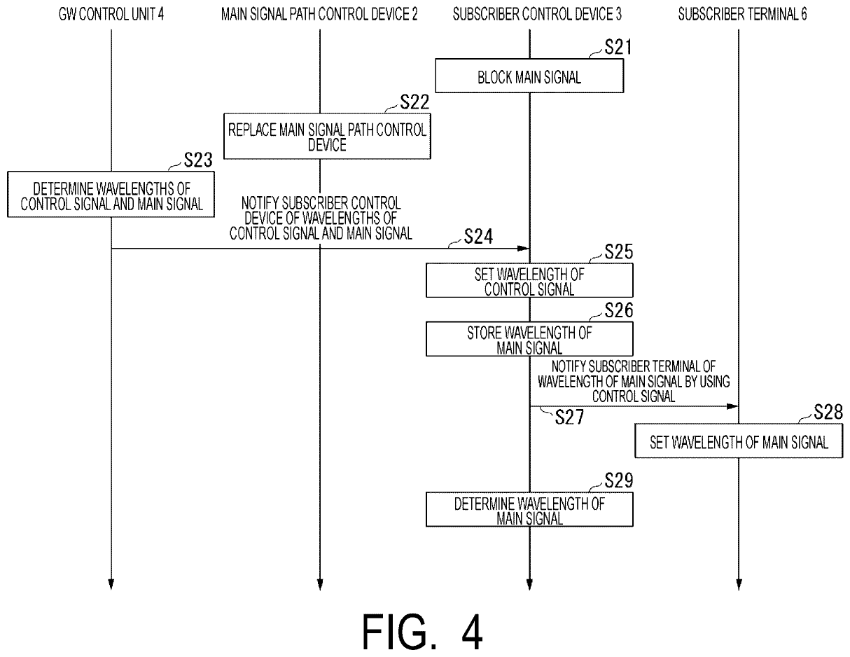

FIG. 4 is a flowchart illustrating a procedure for replacing the main signal path control device 2 in the GW device 1 according to the second embodiment. First, the switch 323 blocks the main signal transmitted and received between the main signal path control device 2 and the optical branching unit 321 (step S21). The switch 323 is controlled by the GW control unit 4, and blocks the main signal. Thereafter, the user of the GW device 1 replaces the main signal path control device 2 with a new device (step S22). Thereafter, the GW control unit 4 determines the wavelengths of the main signal and the control signal for each optical path (step S23). The GW control unit 4 determines the wavelengths such that the wavelengths of the main signal and the control signal are different for each optical path. The GW control unit 4 notifies the control signal transmission/reception unit 311 of the determined wavelengths of the control signal and the main signal, and notifies the optical signal detection unit 322 of the wavelength of the main signal (step S24). The control signal transmission/reception unit 311 sets a wavelength of the control signal to the notified wavelength of the control signal (step S25). In addition, the optical signal detection unit 322 stores the notified wavelength of the main signal (step S26).

The control signal transmission/reception unit 311 transmits a control signal to the subscriber terminal 6 via the multiplexing unit 312. The control signal includes information on the wavelength of the main signal. Thereby, the control signal transmission/reception unit 311 notifies the subscriber terminal 6 of the wavelength of the main signal (step S27). The subscriber terminal 6 sets the notified wavelength as the wavelength of the main signal (step S28). Thereafter, the optical signal detection unit 322 determines whether or not the wavelength of the main signal transmitted from the subscriber terminal 6 is equal to the stored wavelength of the main signal (step S29). In a case where the wavelength of the main signal is equal to the stored wavelength of the main signal, the optical signal detection unit 322 turns on the switch 323 such that the main signal passes between the main signal path control device 2 and the optical branching unit 321. In a case where the wavelength of the main signal is not equal to the stored wavelength of the main signal, the optical signal detection unit 322 notifies the GW control unit 4 that the subscriber terminal 6 connected to the optical path is abnormal.

As described above, in the GW device 1 according to the second embodiment, the optical signal detection unit 322 determines whether or not the wavelength of the main signal output from the connected subscriber terminal 6 is equal to the determined wavelength of the main signal. Thereby, it is possible to prevent wavelength collision or the like from occurring in the main signal path control device 2 in a case where an incorrect subscriber terminal is connected.

### Other Embodiments

Although an embodiment of the present invention has been described in detail with reference to the drawings, the specific configuration is not limited to the above, and various design changes and the like can be made without departing from the gist of the present invention.

The GW control unit 4 is implemented by, for example, a hardware processor such as a central processing unit (CPU) executing a program (software). The GW control unit 4 may be implemented by hardware (a circuit unit including circuitry) such as a large scale integration (LSI), an application specific integrated circuit (ASIC), a field-programmable gate array (FPGA), or a graphics processing unit (GPU), or may be implemented by cooperation of software and hardware. The program may be stored in advance in a storage device (a storage device including a non-transitory storage medium) such as a hard disk drive (HDD) or a flash memory, or may be stored in a removable storage medium (a non-transitory storage medium) such as a DVD or a CD-ROM, and may be installed by attaching the storage medium to the drive device.

### REFERENCE SIGNS LIST

1 GW device
2 Main signal path control device
21 Line concentration/distribution unit
22 Adding/dropping unit
3 Subscriber control device
31 Terminal wavelength control unit
311 Control signal transmission/reception unit
312 Multiplexing unit
32 Main signal blocking unit
321 Optical branching unit
322 Optical signal detection unit
323 Switch
4 GW control unit
5 EX device
6 Subscriber terminal

1. A GW device comprising:
a main signal path control device that performs line concentration/distribution and adding/dropping on a received main signal; and
a subscriber control device that is provided between the main signal path control device and a subscriber terminal and transmits and receives the main signal and a control signal to and from the subscriber terminal,
wherein the main signal path control device is separable from the subscriber control device.

2. The GW device according to claim 1,
wherein the subscriber control device transmits and receives the control signal having a wavelength different from a wavelength of the main signal to and from the subscriber terminal.

3. The GW device according to claim 1 or 2,
wherein the subscriber control device includes a main signal blocker that determines whether to transmit the main signal received from the subscriber terminal to the main signal path control device based on a wavelength of the main signal received from the subscriber terminal.

4. An optical signal processing method comprising:
performing, via a main signal path control device, line concentration/distribution and adding/dropping on a received main signal; and
transmitting and receiving, via a subscriber control device that is provided between the main signal path control device and a subscriber terminal, the main signal and a control signal to and from the subscriber terminal,
wherein the main signal path control device is separable from the subscriber control device.
